(19) United States
(12) Patent Application Publication
(10) Pub. No.: US 2005/0188219 A1
(43) Pub. Date: Aug. 25, 2005

(54) Method and a system for communication between a terminal and at least one communication equipment

(75) Inventors: Etienne Annic, Rambouillet (FR); David Picquenot, Saint Contest (FR); Yves Thorigne, Verson (FR)

Correspondence Address: COHEN, PONTANI, LIEBERMAN & PAVANE;Suite 1210, 551 Fifth Avenue, New York, NY, 10176, US

(73) Assignee: Orange France, Montrouge (FR)

(21) Appl. No.: 11/020,850

(22) Filed: Dec. 23, 2004

(30) Foreign Application Priority Data
Dec. 26, 2003 (EP) 03293342.6

(51) Int. Cl. H04L 9/00

(52) U.S. Cl. 713/200

(57) ABSTRACT

A method of communicating data securely between a terminal and at least one communicating equipment. The communicating equipment in communication with the terminal is identified by at least one first security device installed in the terminal to recognize the nature of the communicating equipment. The communicating equipment is authenticated by acquiring data processed by at least one security server so that it is executable only by the communications equipment. The integrity of the communicating equipment is checked by at least one approval device of the security server using the data transmitted at the time of the authentication, and, in the event of correct identification, authentication and integrity checking at least one management device installed in the terminal is commanded to set up secure data communication with the communicating equipment.

### FIELD OF THE INVENTION

The present invention relates to a method and a system for communication between a terminal and at least one communicating equipment.

The invention applies more particularly to the secure communication of data between a terminal and one or more communicating equipments.

### BACKGROUND OF THE INVENTION

At present, calls set up from a terminal are intended to connect the user of said terminal to various telecommunications networks, either through voice communication, for example telephone communications, or through communication with a packet network such as the Internet, enabling servers on said network to be accessed and browsed.

As a general rule, present day terminal users may seek to upgrade the technical features and capabilities of their terminals by connecting additional equipment to a terminal.

For example, as the screens provided on mobile terminals are of limited size, the user may wish to connect said original mobile terminal physically to additional equipment having a larger screen. In this way the user obtains a more user friendly view of pages from an Internet server, for example. In the same way, the user may connect a camera to the terminal, for example a personal computer (PC), in order to take and transmit photos, for example as attachments to electronic mail messages sent from said terminal to an electronic mailbox.

Once connected to the terminal, the additional equipment is regarded as an integral part of said terminal.

Said terminal can be of any kind, for example a personal computer (PC), a mobile terminal, or any other terminal allowing the addition of communicating equipment.

Whatever the nature of the equipment added to the terminal, it is available to the user, in particular belongs to the user, and is appropriately configured to suit the connection with said terminal. As a general rule, the additional equipment may have parameters that are set so that it is recognized by said terminal. To this end the additional equipment may be configured statically beforehand, by setting parameters, so that communication with the terminal to which it is connected is encrypted by means of a predefined encryption key, for example, which is possible because the terminal and the additional equipment are available to or belong to the same user, who configures appropriately the terminal and the equipment that is to be added to said terminal.

Given that such configuration is necessary for communicating with a terminal, only equipments readily accessible to the user can be added without being rejected by said terminal.

If the user of a terminal wishes to communicate with an equipment that belongs to someone else or that is not physically connected to said terminal, the user may not have free access to the equipment. In particular, the terminal may be located near or far away from equipments with which the user wishes to communicate. Because the user of the terminal is not able to configure the communicating equipment to this end, the configuration of the communicating equipment is not suited to said terminal.

Said communicating equipment is, for example, a communicating automatic device such as a drinks dispenser, a communicating terminal, a communicating paystation, a personal computer (PC), etc., or any kind of terminal including telecommunications means, processing means and data storage means.

The document WO 03/077581 describes a method of authenticating an electronic communications device able to transmit data messages to a server using a data communications synchronization protocol such as the SyncML protocol. The server determines which authentication method to use following the transmission of an initialization message by the communications device. The authentication method is specified by an authentication method indicator included in messages exchanged between the communications device and the server. The authentication method may be different for different electronic communications devices, depending on the functions of the device.

The above method makes no provision for approval of the remote communications device to verify that said device has not been damaged or pirated, providing only a check on the integrity of the transmitted messages.

At present, the component of a mobile terminal that provides security for mobile telephone networks such as GSM (Global System for Mobile communications) networks or GPRS (General Packet Radio Service) networks is a SIM (subscriber identity module) card. The functions of the SIM card include authentication of the user on the mobile network, encryption of speech or data, and customization of the mobile terminal. In the same way, a new UMTS ICC (integrated circuit card) is installed in a mobile terminal connected to a UMTS (Universal Mobile Telecommunications System) network.

The standardization efforts of the 3GPP (Third Generation Partnership Project) relate to a so-called split terminal (“user equipment split”) whose concept is explained in the report “3GPP TR22.944 version 5.1.0, report on service requirements for UE functionality split”. However, the 3GPP neither offers nor describes any implementation or any use of said user equipment split.

### SUMMARY OF THE INVENTION

One object of the invention is to enable a terminal to set up secure communication with at least one communicating equipment, whether the communicating equipment belongs or does not belong to the user of said terminal, with the general aim of expanding secure high added value services.

The technical result obtained, which is preferably implemented in a terminal and in at least one communicating equipment, seeks to offer communications services by way of a connection such as a serial cable link, an IrDA (Infrared Data Association) infrared link, a GPRS mobile telecommunications network, an NFC (near field contactless) communications link or a Bluetooth short-range wireless radio link.

According to one aspect of the invention, this object is achieved by a system for secure data communications between a terminal and at least one communicating equipment, wherein, communication having been set up between said terminal and said communicating equipment, said system comprises at least one security server adapted to exchange data to secure said communication set up with at least one first security device of said terminal which is equipped with at least one first management device for managing said communicating equipment.

Another aspect of the invention is directed to a method of providing secure data communication between a terminal and at least one communicating equipment. The method comprises the steps of: at least one first security device installed in said terminal identifying said communicating equipment in communication with said terminal in order to recognize the nature of said communicating equipment, authenticating said communicating equipment by acquiring data processed by at least one security server to be executable only by said communicating equipment, at least one approval device of said security server checking the integrity of said communicating equipment using said transmitted data at the time of authentication, in the case of identification, authentication and integrity checking results that are all positive, commanding at least one first management device installed in said terminal to set up secure data communication with said communicating equipment.

The communicating equipments may be of different kinds, for example a public communications terminal with a messaging service, a communicating drinks dispenser with an electronic payment application, a communicating toll or parking terminal, a communicating parking meter, an electronic identity card, a personal computer (PC), etc.

Consequently, the equipment E with which the user of the terminal wishes to communicate belongs to someone else and said user does not have free access to it.

The secure data communications system of the invention allows the composition of a split terminal comprising a terminal and at least one communicating equipment. The resulting split terminal enables the terminal user to upgrade the technical features and capabilities of the terminal, with a high level of security, and to access new services which that user was previously unable to access.

The split terminal is obtained irrespective of the nature of said communicating equipment and without having to carry out any configuration process to render the terminal and said equipment compatible, which avoids wasting time and errors in the configuring of said terminal by the user. The compatibility of, and the security of the communication set up between, the terminal and the communicating equipment are obtained automatically, and are suited to any nearby or remote communicating equipment.

A terminal sets up communication with a communicating equipment. The communicating equipment is identified and authenticated by said terminal, which also checks its integrity and is equipped with a first security device and a first management device, and is validated by a security server, which dialogues with said terminal.

All entities of the secure communications system are provided with means for sending and receiving data, enabling data to be exchanged between said entities.

According to an embodiment of the invention, said method includes a step of setting up a link between said terminal and said communicating equipment via at least one connection network.

According to an embodiment of the invention, said link set up via said connection network enables a type of communication selected from the group comprising cable, mobile, optical and short-range radio communications.

Above all else, the terminal sets up communication with a communicating equipment to access the required service, the combination of said terminal and the communicating equipment constituting the split terminal.

The composition of said split terminal is linked to the setting up of a link between said terminal and said communicating equipment.

The terminal and the communicating equipment (toll or parking terminal, parking meter, PC, etc.) communicate via a connection network, for example, a serial cable link, a GPRS mobile telecommunications network, an IrDA (Infrared Data Association) infrared link, an NFC (near field contactless) communications link or a Bluetooth short-range wireless radio link.

According to another embodiment of the invention, the exchange of data between said terminal and said communicating equipment is managed and controlled by at least one first security device and at least one second security device installed in said terminal and said communicating equipment, respectively.

The terminal sets up communication with at least one communicating equipment to compose a split terminal by combining the terminal and said communicating equipment.

The secure communications system allows messages to be exchanged between the terminal and the communicating equipment with a high level of security. Said first security device and said first management device of the terminal, together with the security server, execute and validate identification, authentication and integrity checking irrespective of the nature of said communicating equipment, which is equipped with a second security device that manages exchanges with said terminal constituting the other portion of the split terminal.

According to an embodiment of the invention, at least one procedure for activating secure communication between said terminal and said communicating equipment is identified and processed by said first security device.

As soon as the terminal sets up communication with said communicating equipment, the management of said communicating equipment is configured to compose a split terminal.

A procedure for activating a split terminal is executed to set up secure communication between the terminal and said communicating equipment. To enable the procedure used to be recognized, management of the secure communication uses an identifier corresponding to said communicating equipment with which communication has been set up.

According to an embodiment of the invention, said first security device of said terminal controls automatically at least one process of setting parameters of said secure communication, with no intervention by the user of said terminal.

To increase security, messages to which there has been no response after a time period exceeding a time-out that is a parameter set in said first security device of said terminal automatically leads to aborting of the procedure for activating the split terminal, for example. The maximum number of aborts authorized for an activation procedure corresponding to the same split terminal may also be a parameter that may be set to prevent external hacking.

According to an embodiment of the invention, the result of said communicating equipment decrypting the data processed by said security server is identical to the result of said security server decrypting the identity of said equipment.

According to an embodiment of the invention, to prevent prediction of the result, the decrypting by said communicating equipment of said data processed by said security server depends on the integrity checking performed by said approval device installed in said security server, as a function of the configuration of said communicating equipment at a given time.

To obtain a high level of security in respect of the communication set up between the terminal and the communicating equipment and in respect of the management of the split terminal, security management is shared between the terminal, said communicating equipment and said security server. If any of these three entities detects an anomaly, the procedure for activating the split terminal is aborted.

To prevent fraud, intervention or external misappropriation, said approval device of the security server processes data exchanged between the entities of the secure communications system to check the integrity of the terminal and the communicating equipment.

To this end, a comparison is effected between the result of decrypting the data processed by said security server and the result of decrypting the identity of said communicating equipment.

To improve security, said approval device of the security server selects one pair from a set of pairs of encryption keys available in at least one table of correspondences, as a function of the configuration of said communications equipment at a given time.

According to an embodiment of the invention, said second security device and said second management device of said communicating equipment prohibit intervention on said communicating equipment by said user of said mobile terminal.

This secures the setting up of the split terminal. The user of said terminal is unable to intervene on said communicating equipment in any manner whatsoever, or to intervene externally in any other way; this is to prevent fraud or hacking.

According to an embodiment of the invention, exchange of data between said terminal and said communicating equipment is secured by using at least one encryption key to process the data before transmission.

According to an embodiment the invention, exchange of data between said terminal and said security server is secured by using at least one encryption key to process the data before transmission.

In contrast to the procedure employed in existing systems, encryption is performed in the terminal and in the security server. Moreover, the transmitted data may also be encrypted if messages are exchanged between the various entities of the secure communications system.

According to an embodiment of the invention, a plurality of communicating equipments simultaneously set up communication with said terminal via at least one connection network.

According to an embodiment of the invention, a plurality of communicating equipments communicate independently with said terminal via said connection network.

According to the invention, a procedure for activating said secure communication is identified for each communicating equipment in communication with said terminal.

Depending on the applications required by the user, a plurality of communicating equipments may enter into communication with said terminal simultaneously and independently, for example a drinks dispenser, a communicating toll or parking terminal, a PC, etc., and connected to said terminal by at least one connection network. Communication between said terminal and at least one communicating equipment is set up via said connection network.

The secure data communications system of the invention enabling the composition of a split terminal by combining a terminal and at least one communicating equipment may be transposed to any type of connection network and to any communicating equipment having functions and communications means suited to the composition of a split terminal.

A totally secure procedure for activating a split terminal is executed independently for each of said communicating equipments. To enable identification of the various procedures for simultaneously activating said “split terminals”, the messages all have different identifiers.

### BRIEF DESCRIPTION OF THE DRAWINGS

FIG. 1 represents the general architecture of a system of the invention for secure communication between a terminal and at least one communicating equipment.

FIG. 2 shows the steps of a method of the invention for secure communication between a terminal and at least one communicating equipment.

### DETAILED DESCRIPTION OF THE DRAWINGS

The secure data communications system of the invention enables a split terminal to be composed by combining a terminal 20 and at least one communicating equipment E 30, 30′. Said split terminal constitutes a technical solution embodying the concept set out in the above 3GPP technical report.

The resulting split terminal enables the user of the terminal 20 to upgrade the technical features and capabilities of the terminal in total security, irrespective of the nature of said communicating equipment E 30, 30′.

The composition of said split terminal is linked to the setting up of a link between said terminal 20 and said communicating equipment E 30, 30′, which is connected to the terminal via at least one connection network 50.

Said connection network 50 supports types of communication selected from the group comprising cable, radio, optical and short-range radio communication, such as cable serial links, GPRS mobile telecommunications networks, IrDA (Infrared Data Association) infrared links, NFC (near field contactless) communications links or Bluetooth short-range wireless radio links.

Said terminal 20 can be of any kind, for example a personal computer (PC), a mobile terminal, or any other terminal allowing the addition of a communicating equipment E 30, 30′.

The communicating equipments E 30, 30′ may be of various kinds, for example a public communications terminal with a messaging service, a communicating drinks dispenser with an electronic payment application, a communicating toll or parking terminal, a communicating parking meter, a personal computer (PC), etc.

Consequently, the equipment E with which the user of the terminal wishes to communicate might belong to someone else, in which case the user does not have free access to it.

The composition of the split terminal is achieved irrespective of the nature of said communicating equipment and without having to carry out any configuration process to render the terminal and said equipment compatible, which avoids wasting time and errors in the configuration of said terminal by the user. The compatibility and security of the communication set up between the terminal and the communicating equipment are achieved automatically and suited to any kind of nearby or remote communicating equipment.

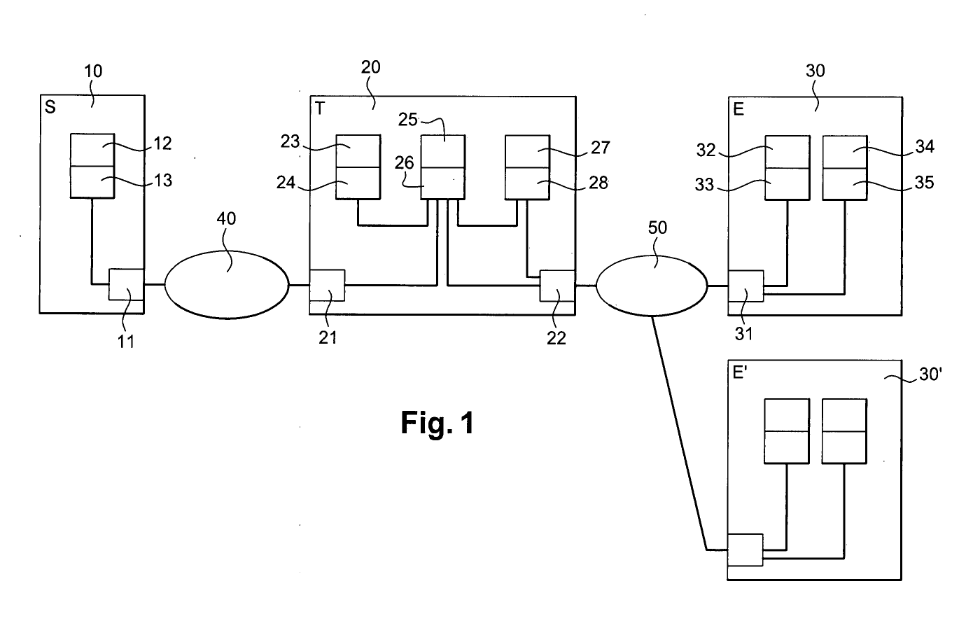

In FIG. 1, which represents a system embodying the invention, the equipments concerned are at least one security server (S) 10, at least one terminal (T) 20 and at least one communicating equipment (E) 30, 30′.

Said security server 10 comprises at least one approval device 12 for checking and validating the identification, authentication and integrity checking of at least one communicating equipment E 30, 30′ when said communicating equipment E 30, 30′ is combined with a terminal 20 to compose a split terminal. Said approval device 12 is equipped with a communications interface 13 consisting at least of means for sending and receiving data able to exchange messages with a first transmission interface 11 of said security server 10. Said first transmission interface 11, consisting at least of means for sending and receiving data, enables exchange of transmitted data with said terminal 20, which is equipped with a second transmission interface 21. Said security server 10 is able to control said first security device 25 of said terminal 20 and exchange data with it to set up secure data communication with said communicating equipment E 30, 30′. Transmission between said security server 10 and the terminal 20 is effected via at least one access network 40.

Said access network 40 supports forms of communication selected from the group comprising cable, mobile, optical and short-range radio communication, such as a serial cable link, an IrDA (Infrared Data Association) infrared link, a GPRS mobile telecommunications network, a NFC (near field contactless) communications link or a Bluetooth short-range wireless radio link.

Said terminal 20 comprises at least one user interface 23, at least one first security device 25 and at least one first management device 27 for managing said communicating equipment E 30, 30′.

The user interface 23 enables the user to access the resources of the terminal 20, for example display means, such as a screen, or sound or voice reproduction means, data entry means, such as a keypad, or data storage means, such as a memory of a said terminal 20. The user interface 23 outputs the transmitted messages to inform the user of said terminal 20 of their contents and enables validation and acceptance by said user of the setting up of said communication according to the nature of said communicating equipment E 30, 30′ and the procedure for activating a split terminal. Said user interface 23 is equipped with a communications interface 24 consisting at least of means for sending and receiving data, adapted to exchange messages with a communications interface 26 of the first security device 25 of said terminal 20.

The first security device 25 of the terminal 20 is responsible for identification, authentication and integrity checking on setting up communication with at least one communicating equipment E 30, 30′ when said communicating equipment E 30, 30′ is combined with the terminal 20 to compose a split terminal. The first security device 25 receives the identity of said communicating equipment E 30, 30′ and is adapted to recognize the nature of said communicating equipment E 30, 30′ and to dialogue with said security server 10 to secure said communication set up between the terminal 20 and the communicating equipment E 30, 30′. Said first security device 25 is also equipped with a communications interface 26 consisting at least of means for sending and receiving data and adapted to exchange messages with a communications interface 28 of the first management device 27 of said terminal 20.

The first management device 27 of said terminal 20 is responsible for managing the split terminal composed by combining the terminal 20 with at least one communicating equipment E 30, 30′. The first management device 27 is equipped with a communications interface 28 consisting at least of means for sending and receiving data and adapted to exchange messages with said communications interface 26 of the first security device 25 of said terminal 20 and to exchange messages with said third transmission interface 22 compatible with said connection network 50.

Said communications interface of the first security device 25 of said terminal 20 is adapted to exchange messages with the second transmission interface 21 and the third transmission interface 22, in addition to exchanging data with said communications interfaces 24 and 28 of said terminal 20. Said second transmission interface 21 of said terminal 20 consists at least of means for sending and receiving data and enables exchange of transmitted data with said security server 10, which is equipped with said first transmission interface 11. Transmission between said security server 10 and the terminal 20 is effected via said access network 40. Said third transmission interface 22 of said terminal 20 consists at least of means for sending and receiving data and enables exchange of transmitted data with at least one communicating equipment E 30, 30′, which is equipped with a fourth transmission interface 31. Transmission is set up between said terminal 20 and said communicating equipment E 30, 30′ via at least one connection network 50.

Said third transmission interface 22 and fourth transmission interface 31 of the terminal 20 and said communicating equipment E 30, 30′ are compatible with said connection network 50.

If different communicating equipments E 30, 30′ are connected to different types of connection network 50, each communicating equipment E 30, 30′ is equipped with a transmission interface 31 compatible with the corresponding type of connection network 50. Communication may then be set up with a terminal 20 equipped with a third transmission interface 22 compatible with the type of connection network 50 to which said communications equipments E 30, 30′ are connected. A plurality of communicating equipments E may simultaneously and independently set up communication with said terminal via at least one connection network 50.

The terminal 20 may be equipped with different transmission interfaces 22 corresponding to different types of connection network 50.

Said communicating equipment E 30, 30′ comprises at least one second security device 32 responsible for identification, authentication and integrity checking at the time of setting up communication with a terminal 20 and at least one second management device 34 for managing said terminal 20. Said second security device 32 of the communicating equipment E 30, 30′ is equipped with a transmission interface 33 consisting at least of means for sending and receiving data adapted to exchange messages with said fourth transmission interface 31, which is compatible with said connection network 50.

Said second management device 34 of the communicating equipment E 30, 30′ manages the split terminal comprising the combination of the terminal 20 and said communicating equipment E 30, 30′. The second management device 34 is equipped with a communications interface 35 comprising at least means for sending and receiving data adapted to exchange messages with said communications interface 33 of said second security device 32 of said communicating equipment E 30, 30′ and to exchange messages with said fourth transmission interface 31, which is compatible with said connection network 50.

Said second security device 32 and said second management device 34 of said communicating equipment 30, 30′ prohibit intervention on said communicating equipment 30, 30′ by the user of said mobile terminal 20. This secures the setting up of said split terminal. In this way, the user of said terminal 20 may not intervene on the communicating equipment 30, 30′ in any way, or effect any other external intervention, to prevent fraud, hacking or access to parameter settings.

Depending on the applications required by the user, a plurality of communicating equipments E 30, 30′ may enter into communication with said terminal 20 simultaneously and independently, for example a drinks dispenser, a communicating toll or parking terminal, a PC, etc. connected to said terminal 20 via at least one connection network 50. Communication between said terminal 20 and at least one communicating equipment E 30, 30′ is set up via said connection network 50. A procedure for activating secure communication is identified for each communicating equipment 30, 30′ in communication with said terminal 20.

The communicating equipment E 30, 30′ is not always physically near the terminal 20. For example, said communicating equipment E 30, 30′ may be an application server in a data network, in particular the Internet, or a company private network. In this case, said communicating equipment E 30, 30′ is connected to said terminal 20 via a connection network 50, for example a GPRS (General Packet Radio Service) mobile telecommunications network or the Internet.

Generally speaking, the secure data communications system of the invention providing for the composition of a split terminal comprising the combination of a terminal 20 and at least one communicating equipment E 30, 30′ may be transposed to any type of connection network 50, whether it is a mobile network (for example a UMTS mobile network), a fixed network (for example an ADSL network), a cable link (for example a serial link), a contactless link (for example an NFC link), or an optical link (for example an IrDA infrared link), etc.

It may also be transposed to any communicating equipment E 30, 30′ whether it be a communicating watch or clothing accessory, a sensor on a communicating machine, a communicating medical tool or measuring tool, etc., or any equipment E having the communications means and functions needed to constitute a split terminal.

The composition of said split terminal is linked to the setting up of a link via said connection network 50 between said terminal 20 and at least one communicating equipment E 30, 30′.

The setting up of communication between the terminal 20 and a communicating equipment E 30, 30′ may be activated either at the initiative of the user of the terminal 20 or by the recognition of the presence of a communicating equipment E 30, 30′ in the vicinity of said terminal 20.

If communication is activated at the initiative of the user, said user commands the terminal 20 to set up a link via the existing connection network 50; for example, the user places the terminal 20 in front of an NFC sensor of a contactless access network and then launches a procedure for activating a split terminal consisting of the combination of said terminal 20 and at least one communicating equipment E 30, 30′.

If communication is activated by recognition of the presence of a communicating equipment, said third transmission interface 22 of the terminal 20 detects the presence of said fourth transmission interface 31 of at least one communicating equipment E 30, 30′. For example, on detection of said third transmission interface 22, the fourth transmission interface 31 of the communicating equipment E 30, 30′ may send an interrupt message to the operating system of the terminal 20; when it receives said interrupt message, said operating system launches the procedure for activating the split terminal.

A procedure for activating a split terminal is executed to set up secure communication between the terminal and said communicating equipment. A procedure for activating secure communication between the terminal 20 and said communicating equipment E 30, 30′ is identified and processed by said first security device 25. To enable the procedure used to be recognized, the secure communication is managed using an identifier corresponding to said communicating equipment E 30, 30′ with which communication has been set up.

To increase the security of communication between the terminal 20 and said communicating equipment E 30, 30′, this combination being referred to as a split terminal, security management is shared between the terminal 20, said communicating equipment E 30, 30′, and at least one security server 10. If any of these three entities detects an anomaly, the procedure for activating the split terminal is aborted.

Moreover, as soon as the procedure for activating a split terminal begins, a time-out is started after sending each message. The duration of said time-out may be predefined or set by means of a parameter. If the duration of the time-out exceeds the predefined or parameter value, the current activation procedure is aborted. No further account is taken of any messages with an identifier corresponding to said aborted activation procedure. Messages to which there has been no response after a time greater than the predefined or parameter time-out value also cause the procedure for activating the split terminal to be aborted. Another parameter that may be set is the maximum number of aborts allowed for an activation procedure corresponding to the same split terminal, i.e. to the combination of the same terminal 20 and the same communicating equipment E 30, 30′.

Once the parameter value of the number of aborts for the anomaly is reached, activation of the corresponding split terminal becomes impossible.

Thus setting parameters enabling said secure communication is controlled automatically by the first security device 25 of the terminal 20, without intervention by the user of said terminal 20.

In all cases of failure, said terminal 20 receives a message regarding the stopping of the setting up of said secure communication via said user interface 23.

Consequently, this form of shared management provides a high level of security and prevents the fraudulent or inappropriate creation of a split terminal. Moreover, the approval device 12 of the security server 10, the second security device 32 of the communicating equipment E 30, 30′, and the first security device 23 of the terminal 20 may take the form of a smart card or a secure electronic component having the functions described below of the method of activating the split terminal, for example. The smart card may be an SIM card or a UICC card, for example, as defined in the standards of the 3GPP (Third Generation Partnership Project) standardization group and the ETSI (European Telecommunications Standards Institute).

Moreover, to secure communication between the various entities of the system according to the invention and to authenticate said entities to each other, the messages transmitted are encrypted, for example using an existing public key/private key or symmetrical key encryption method. In accordance with the encryption method, when an entity of said secure communications system encrypts a message M using a key K, the message K(M) may be read only by the entity holding the complementary key K′. With public key/private key encryption, a key K corresponds to a complementary key K′ and, the message M as encrypted by the key K being denoted K(M), the result of encryption of the message K(M) by the complementary key K′ is equal to the message M. In the case of symmetrical key encryption, the keys K and K′ are identical.

Exchange of data between said terminal 20 and, firstly, said communicating equipment E 30, 30′ and, secondly, said security server 10, is secured by processing the data before transmission. Transmission between the first security device 25 of the terminal 20 and, firstly, the second security device 32 of said communicating equipment E 30, 30′ and, secondly, the approval device 12 of said security server 10, is also encrypted.

Exchange of data between said terminal 20 and said communicating equipment E 30, 30′ is managed and controlled by at least one first security device 25 and at least one second security device 32 installed in said terminal 20 and in said communicating equipment E 30, 30′, respectively.

The secure communications system of the invention provides for the approval device 12 of the security server 10 to hold keys KA′, KB, KC, KD′ and temporary keys KTA and KTA′. The first security device 25 of the terminal 20 holds the keys KB′ and KD and the temporary keys KTB and KTB′. The second security device 32 of the communicating equipment E 30, 30′ holds the keys KC′ and KA and the temporary keys KTC and KTC′. The temporary keys are used to encrypt and authenticate communication after a positive result of the procedure for activating said split terminal. The temporary keys KTA, KTA′, KTB, KTB′, KTC, KTC′ are preferably symmetrical keys, offering better encryption performance. The other keys KA, KA′, KB, KB′, KC, KC′, KD and KD′ are preferably asymmetrical keys conforming to the public key/private key principle.

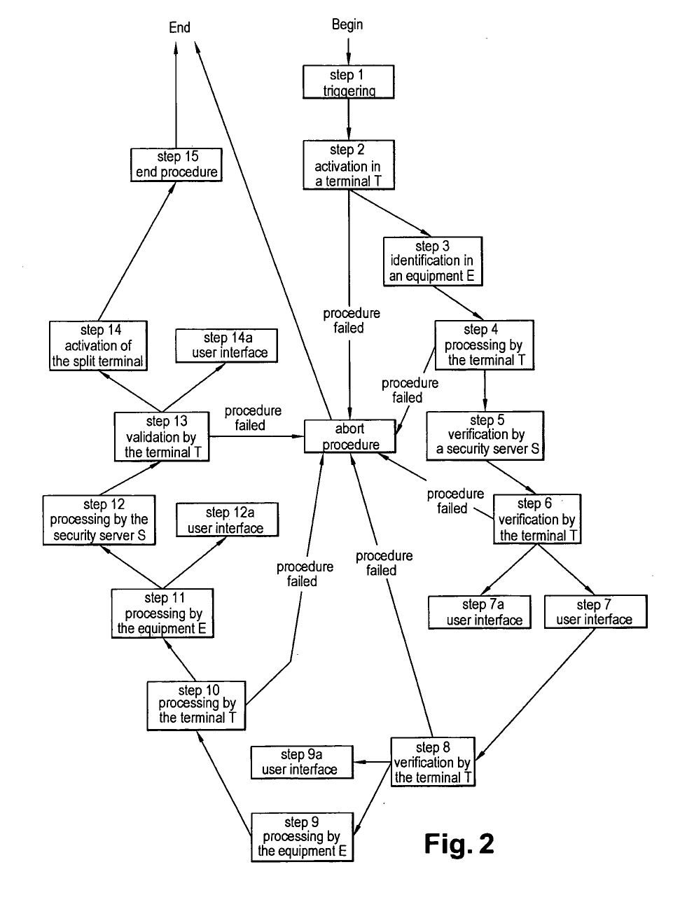

To assist with understanding the invention, FIG. 2 shows the steps of the method of secure communication between a terminal 20 and at least one communicating equipment E 30, 30′.

As mentioned above, the procedure for activating the split terminal (step 1) is triggered either by the terminal 20 or by at least one communicating equipment E 30, 30′.

In the case of triggering by the terminal 20, the user may command the procedure for activating a split terminal by selecting it on the user interface 23 of the terminal 20, for example by means of a hypertext link on a web page displayed on a screen. The user interface 23 then commands the first security device 25 of the terminal 20 to execute a procedure for activating a split terminal via the communications interfaces 24 and 26. Otherwise, the communicating equipment E 30, 30′ may trigger said activation procedure.

In both cases, the first security device 25 of the terminal 20 generates an identifier corresponding to the current activation procedure. As mentioned above, a plurality of communicating equipments E 30, 30′ may set up communication with said terminal 20. Consequently, each request for activation of a split terminal comprising a different communicating equipment E 30, 30′ is identified by an identifier in the first security device 25.

Said first security device 25 of the terminal 20 requests the identification of said communicating equipment E 30, 30′. Said first security device 25 sends an identification interrogation message to the second security device 32 of the communicating equipment E 30, 30′ via the communications interface 26 and the third transmission interface 22 of the terminal 20, the connection network 50, the fourth transmission interface 31 and the transmission interface 33 of the communicating equipment E 30, 30′. Said identification interrogation message contains the identifier of the current activation procedure and the message type “identification request” (step 2).

For example, if the connection network 50 uses an infrared link, the terminal 20 and the communicating equipment E 30, 30′ must each be equipped with an IrDA infrared link transmission interface 22, 31. When an infrared link has been set up between the terminal 20 and at least one communicating equipment E 30, 30′, the third transmission interface 22 of the terminal 20 sends a message via the communications interface 26 to the first security device 25 to request identification of said communicating equipment E 30, 30′. Irrespective of how it is triggered, the message transmitted contains a request for identification of the communicating equipment E 30, 30′.

Exchange of messages in the terminal 20 may be effected in accordance with a protocol conforming to the SIMAccess protocol described in French Patent Application FR 02 15521 filed 9 Dec. 2002, for example. Exchange of data on the connection network 50 and in the communicating equipment E 30, 30′ may be effected in accordance with the Simple Object Access Protocol (SOAP) defined by the W3C (World Wide Web Consortium) standardization organization, for example. For increased security, communication via connection network 50 may also be encrypted. As described above, the current activation procedure may be aborted at any time if an exchange fails.

Following reception of the “identification request” message, the second security device 32 of the communicating equipment E 30, 30′ sends the first security device 25 of the terminal 20 a response message to the identification request containing the identifier corresponding to the current activation procedure, the message type “identification request response”, and the encrypted identity IC that results from encryption by the key KA of the identity IE of the communicating equipment E 30, 30′ and of the identifier corresponding to the current activation procedure (step 3).

To prevent fraudulent access or manipulation from the terminal 20 in particular, the key KA is used to encrypt the identity IE of the communicating equipment E 30, 30′ so that said identity may be decrypted only by the approval device 12 of the security server 10 holding the key KA′. The identifier corresponding to the current activation procedure is used to add a random value to the encryption product. In this way, the product IC always gives a different result and may not be reproduced by simple copying, the identifier varying on each procedure activation.

Following reception of the “identification request response” message, the first security device 25 of the terminal 20 sends the approval device 12 of the security server 10, via the communications interface 26 and 13, the transmission interfaces 21 and 11 and an access network 40, a message containing the identifier corresponding to the current activation procedure, the message type “identity consultation”, the identity IC of the communicating equipment E 30, 30′ encrypted by the key KD (i.e. the product KD(IC)) and a condensate COCI that is produced by encrypting the preceding components of the message (step 4) using the key KD. The condensate COCI is used for validation of the message and authentication of the sending device by the destination device.

A condensate encrypted by a sending equipment using a key is decrypted by a destination equipment using the complementary key, and this authenticates the device sending the message. In the present instance, the first security device 25 of said terminal 20, which is the sending device, encrypts the condensate COCI using the key KD and the approval device 12 of the security server 10, which is the receiving device, decrypts the condensate COCI using the complementary key KD′. The first security device 25 then encrypts the product IC using its key KD. In this way the approval device 12 is certain that the first security device 25 has validated the starting of the activation procedure by decrypting the product KD(IC).

Messages may be exchanged in the terminal 20 by means of the SIMAccess protocol, for example, which is described in French Patent Application FR 02 15521 filed Dec. 9, 2002. Exchanges on the access network 40 and in the security server 10 may be effected by means of the existing simple object access protocol (SOAP), for example. To increase security, communication via the access network 40 may also be encrypted. As stated above, the current activation procedure may be aborted at any time if an exchange fails.

Following reception of the “identity consultation” message, the approval device 12 of the security server 10 decrypts the condensate COCI and the product KD(IC) using its key KD′ (step 5). Said approval device 12 deduces the validity of the message and the product IC. Knowing the identifier of the current activation procedure, and holding the key KA′, it decrypts the product IC and deduces the identifier IE of the communicating equipment E 30, 30′. A first table of correspondences contains a list of the identifiers IE, the keys KC and the nature of the equipments E, such as a toll terminal, a parking meter, etc. Knowing the identity IE of the communicating equipment E 30, 30′, the approval device 12 deduces the key KC of the communicating equipment E 30, 30′ and the nature of the communicating equipment E 30, 30′. The approval device 12 considers the communicating equipment E 30, 30′ to have been identified if decryption proceeds correctly and if the identity IE of the communicating equipment E 30, 30′ and the identifier of the current activation procedure conform to the information contained in the first table of correspondences of said approval device 12.

Using a second table of correspondences, said approval device 12 deduces a set of seal key CSH+integrity checking software AVI pairs from the identity IE of the communicating equipment E 30, 30′. Executing the software AVI checks the integrity of the communicating equipment E 30, 30′ by virtue of the AVI software acquiring seal keys corresponding to the configuration of said communicating equipment E 30, 30′ at a given time. A pair is chosen at random from all the pairs available in said second table of correspondences. The approval device 12 then chooses a pair of encryption keys (KTA, KTA′) at random from all the pairs available in a third table of correspondences. Said approval device 12 encrypts the key KTA using the key KB (product KB(KTA)), the key KTA′ encrypted by the key KC, the combination encrypted by the key KB (product KB(KC(KTA′))) and the software AVI encrypted by the key KC (product KC(AVI)).

To prevent prediction of the result, by virtue of the random selection from a set of pairs of encryption keys, the decryption of the data processed by the approval device 12 of said security server 10 and executed by said communicating equipment E 30, 30′ depends on the integrity checking effected by said approval device 12, as a function of the configuration of said communicating equipment E 30, 30′ at a given time.

The approval device 12 of the security server 10 sends the first security device 25 of the terminal 20 a message containing the identifier of the current activation procedure, the message type “positive response to identity consultation”, the nature in clear of the communicating equipment E 30, 30′, the product KB(KTA), the product KB(KC(KTA′)), the product KC(AVI), and the condensate CORP that is the result of encryption by the key KB of the preceding components of this message (step 6).

If any of the above operations of this step fails, said approval device 12 of the security server 10 sends the first security device 25 a message containing the identifier of said activation procedure, the message type “negative response to identity consultation”, and the condensate CORP that is the result of encryption by the key KB of the preceding components of this message.

The identification and authentication of the second security device 32 of the communicating equipment E 30, 30′ are effected at the time of decrypting IC and looking up its identity in the table of correspondences. The integrity check is effected by the approval device 12, which alone knows the result of executing said software AVI on the communicating equipment E 30, 30′. The expected result is a seal key CSH. Execution of the software AVI yields another seal key CSE which must be identical to CSH, if the integrity check on the communicating equipment E 30, 30′ yields a positive result. To prevent prediction of the CSE result, the software AVI is selected at random by the approval device 12 from several that are available. The communicating equipment E 30, 30′ therefore cannot predict the result, which prevents fraudulent manipulation.

The approval device 12 assigns a pair of temporary keys (KTA′, KTA) to enable encryption of exchanges between the first security device 25 of the terminal 20 and the second security device 32 of the communicating equipment E 30, 30′, these temporary encryption keys being needed to secure exchange of data between the terminal 20 and the communicating equipment E 30, 30′ during operation of the split terminal.

The key KTA is encrypted using the key KB and is recognized by the first security device 25 of the terminal 20. The key KTA′ is encrypted using the key KC and then using the key KB. In this way, the key KTA′ is transmitted to the second security device 32 of the communicating equipment E 30, 30′ only if the first security device 25 of the terminal 20 has previously agreed to this on decrypting the product KB(KC(KTA′)).

The software AVI is encrypted using the key KC, so that it can be decrypted only by the second security device 32 of said communicating equipment E 30, 30′ and thereby prevent hacking or attempted fraud from the first security device 25 of said terminal 20 on encrypting the software AVI.

If the message type is “positive response to identity consultation”, the first security device 25 of said terminal 20 decrypts it using its key KB′ and deduces the validity of the message by decrypting the condensate CORP, the key KTA and the product KC(KTA′). Said first security device 25 sends the user interface 23, via the communications interfaces 26 and 24, a message containing the identifier of the current activation procedure, the message type “identification accepted”, and the nature in clear of the communicating equipment E 30, 30′ (step 7). Depending on the resources installed on the terminal 20, the user views the nature of said communicating equipment E 30, 30′ on the screen of said terminal 20, for example.

If the message type is “negative response to identity consultation”, the first security device 25 of said terminal 20 decrypts the condensate CORP using its key KB′ and deduces the validity of the message.

If the message type is “negative response to identity consultation” or if any of the preceding operations of this step fails, the first security device 25 stops the activation procedure and sends the user interface 23, via the communications interfaces 24 and 26, a message containing the identifier of the current activation procedure and the message type “defective identification” (step 7a). Exchanges between the communications interfaces 24 and 26 may be effected by means of the SIMAccess protocol, for example.

Following reception of the “defective identification” message, the user interface 23 of the terminal 20 issues a message to inform the user of the cause of the failure of the current activation procedure. Depending on the resources installed on the terminal 20, output may be visual via a screen, by audio, by voice, etc. In the event of failure, the user of said terminal 20 receives a message reporting the stopping of the setting up of communication with the communicating equipment E 30, 30′.

Following reception of the message “identification accepted”, the user interface 23 issues a message indicating the nature in clear of the communicating equipment E 30, 30′ and may offer the option to continue the current activation procedure. For example, the message may be displayed in the form of a web page if the user interface 23 is an Internet browser. The user gives the command to continue or not to continue the activation procedure by validating the setting up of communication with the communicating equipment E 30, 30′. If the command is to continue, the user interface 23 sends the first security device 25 of the terminal 20 a message containing the identifier of the current activation procedure and the message type “procedure acceptance”. If the command is not to continue, the user interface 23 sends said first security device 25 a message containing the identifier of the current activation procedure and the message type “procedure aborted”.

If the message type is “procedure accepted”, the first security device 25 of the terminal 20 chooses a pair of keys (KTB, KTB′) from all the pairs available in a table of correspondences. It encrypts the key KTB using the key KTA (product KTA(KTB)) (step 8).

The first security device 25 of the terminal 20 sends the second security device 32 of the communicating equipment E 30, 30′ a message containing the identifier of the current activation procedure, the message type “authentication request”, the product KC(KTA′), the product KTA(KTB), the product KC(AVI), and the condensate CODA that is the result of encryption by the key KTA of the preceding components of this message (step 9).

The first security device 25 of the terminal 20 assigns a pair of temporary keys (KTB′, KTB) to enable encryption of exchanges in the direction from the second security device 32 of the communicating equipment E 30, 30′ to the first security device 25 of the terminal 20. The first security device 25 encrypts the key KTB using the key KTA to guarantee that only the second security device 32 of the communicating equipment E 30, 30′, which is in a position to know the key KTA′, is able to decrypt the product KTA(KTB) and thus to extract the key KTB.

If the message type is “procedure aborted” or if any of the preceding operations of this step fails, the first security device 25 of the terminal 20 stops the current activation procedure and sends the user interface 23 a message containing the identifier of the current activation procedure and the message type “procedure aborted” (step 9a).

Following receipt of the “procedure aborted” message, the user interface 23 of the terminal 20 issues a message informing the user of the cause of failure of the current activation procedure. Depending on the resources available on the terminal 20, this output may be visual via a screen, by audio, by voice, etc. In the event of failure, the user of said terminal 20 receives a message reporting the stopping of the setting up of communication with the communicating equipment E 30, 30′.

Following receipt of the “authentication request” message, the second security device 32 of the communicating equipment E 30, 30′ decrypts using its key KC′ and deduces the software AVI and the encryption key KTA′ and using the key KTA′ deduces the key KTB and the validity of the message by decrypting the condensate CODA.

Said second security device 32 executes the software AVI, which is referred to as being “signed” because it is designed to run only on a communicating equipment E 30, 30′ of the type identified above by the approval device 12. It is also designed to produce a “seal key CSE”, also known as a hashing key or hashing, from data acquired during execution of the software AVI in the communicating equipment E 30, 30′. Upon acquiring the data in said communicating equipment E 30, 30′, the software AVI can be executed only by said communicating equipment E 30, 30′ that has been authenticated in this way. The information acquired may be a file name, the date and time of the internal clock of the communicating equipment E 30, 30′, the memory space used, etc., for example, or a combination of the above information.

Following execution of the software AVI, said second security device 32 of the communicating equipment E 30, 30′ chooses a pair of keys (KTC, KTC′) at random from all the available pairs contained in a table of correspondences. Said second security device 32 encrypts the seal key CSE encrypted by the key KA and the combination encrypted by the key KTB (product KTB(KA(CSE))). It also encrypts the key KTC using the key KTB (product KTB(KTC)). The second security device 32 of the communicating equipment E 30, 30′ sends the first security device 25 of the terminal 20 a message containing the identifier of the current activation procedure, the message type “authentication response”, the product KTB(KA(CSE)), the product KTB(KTC), and the condensate CORA that results from encryption by the key KTB of the preceding components of this message (step 10).

The second security device 32 of the communicating equipment E 30, 30′ assigns a pair of temporary keys (KTC′, KTC) to enable the encryption of exchanges in the direction from the first security device 25 of the terminal 20 to the second security device 32 of the communicating equipment E 30, 30′. The second security device 32 encrypts the key KTC using the key KTB with a view to secure transfer of the key KTC to the first security device 25 of the terminal 20. The seal key CSE is encrypted using the key KA and then using the key KTB, thereby guaranteeing that the first security device 25 of the terminal 20 has validated the product KTB(KA(CSE)) by decrypting it and the key KA guaranteeing that the key CSE was sent by the second security device 32 of the communicating equipment E 30, 30′ and can be decrypted only by the approval device 12, with no possibility of misappropriation or fraud from the first security device 25 of the terminal 20.

Following sending of the “authentication response” message, said second security device 32 sends the second management device 34, via the communications interfaces 33 and 35, a request for activation of the split terminal in the form of a message containing the identifier of the current activation procedure, the message type “activation of split terminal with equipment E”, and the keys KTB and KTC′ (step 11).

Exchanges between the communications interfaces 33 and 35 may be effected in accordance with the SIMAccess protocol, for example.

If any of the preceding operations of this step fails, the second security device 32 of the communicating equipment E 30, 30′ sends the first security device 25 of the terminal 20 a message containing the identifier of the current activation procedure, the message type “authentication anomaly”, and the condensate CORA that is the result of encrypting the preceding components of this message using the key KTB. The current activation procedure is aborted.

If the message type is “authentication response”, the first security device 25 of the terminal 20 decrypts using its key KTB′ and deduces the product KA(CSE), the key KTC and the validity of the message by decrypting the condensate CORA. Said first security device 25 encrypts the product KA(CSE) encrypted using the key KD (product KD(KA(CSE))) to validate correct transmission by the first security device 25 of the terminal 20. It sends the approval device 12 of the security server 10 a message containing the identifier of the current activation procedure, the message type “authentication validation”, the product KD(KA(CSE)), and the condensate CORC that is the result of encrypting the preceding components of this message (step 12) using the key KD. The first security device 25 of the terminal 20 encrypts the product KA(CSE) using the key KD to validate correct transmission from said first security device 25.

If the message type is “authentication anomaly”, said first security device 25 decrypts using its key KTB′ and deduces the validity of the message by decrypting the condensate CORA. If the message type is “authentication anomaly” or if any of the preceding operations of this step has failed, said first security device 25 stops the current activation procedure and sends the user interface 23 a message containing the identifier of the current activation procedure and the message type “defective authentication” (step 12a).

Following reception of the “defective authentication” message, the user interface 23 of the terminal 20 may send a message to tell the user the cause of failure of the activation procedure. Depending on the resources available on the terminal 20, this output may be visual via a screen, by audio, by voice, etc. In the event of failure, the user of said terminal 20 receives a message regarding the stopping of the setting up of communication with the communicating equipment E 30, 30′.

Following receipt of the “authentication validation” message, the approval device 12 of the security server 10 decrypts using its key KD′ and deduces the validity of the message by decrypting the condensate CORC and the product KA(CSE). Said approval device 12 then decrypts using its key KA′ and deduces the seal key CSE. Said approval device 12 compares the seal key CSE with the seal key CSH obtained previously by means of the table of correspondences (identifier of the equipment E, (seal key CSH, software AVI)).

If the two seal keys CSH and CSE are identical, the communicating equipment E 30, 30′ is considered authenticated, because the communicating equipment E 30, 30′ is undoubtedly holding the key KC′, and is integrated because the two seal keys match. Consequently, the result of decrypting the data processed by said security server 10 executed only by said communicating equipment E 30, 30′ is identical to the result of decrypting the identity of said communicating equipment E 30, 30′ in said security server 10. The data processed by said security server 10 has been executed only by the communicating equipment E 30, 30′ corresponding to said split terminal.

Otherwise, because it is not integrated, said communicating equipment E 30, 30′ is considered corrupted, non-authenticated, or the subject of fraud or hacking. The approval device 12 of the security server 10 sends the first security device 25 of the terminal 20 a message containing the identifier of the current activation procedure, the message type and a condensate COVC that is the result of encrypting the preceding components of this message using the key KB (step 13). The message type is either “integrity check verification positive” or, if any of the preceding operations of this step has failed, “integrity check verification negative”.

Following receipt of the above message, the first security device 25 of the terminal 20 decrypts using its key KB′ and deduces the validity of the message by decrypting the condensate COVC. If the message type is “integrity check verification positive”, said first security device sends the first management device 27, via the communications interfaces 26 and 28, a request for activation of the split terminal in the form of a message containing the identifier of the current activation procedure, the message type “split terminal activation”, and the keys KTC and KTB′ (step 14). Exchanges between the communications interfaces 26 and 28 of the terminal 20 may be effected in accordance with the SIMAccess protocol, for example.

If the message type is “integrity check verification negative”, or if any of the preceding operations of this step has failed, the first security device 25 of the terminal 20 stops the activation procedure and sends the user interface 23 a message containing the identifier of the current activation procedure, the message type “equipment corrupted”, and the identity of the communicating equipment E 30, 30′ (step 14a).

Following receipt of the “equipment corrupted” message, the user interface 23 of the terminal 20 may send a message to tell the user the cause of failure of the current activation procedure. Depending on the resources available on the terminal 20, the output may be visual via a screen, by audio, by voice, etc. In the event of failure, the user of said terminal 20 receives a message regarding the stopping of the setting up of communication with the communicating equipment E 30, 30′.

Once the “split terminal activation” message is received, the split terminal activation procedure has been executed successfully (step 15). The first management device 27 of the terminal 20 is able to communicate securely with the communicating equipment E 30, 30′, the keys KTC and KTB′ being used to secure uplink and downlink communications, respectively, between said first management device 27 of the terminal 20 and the second security device 32 of the communicating equipment E 30, 30′.

When this step has been completed, the split terminal comprising the terminal 20 and the communicating equipment E 30, 30′ is operational and is then considered to have been activated.

The first management device 27 of the terminal 20 and the second management device 34 of the communicating equipment E 30, 30′ are then able to communicate with each other securely by encryption using the keys KTB, KTB′, KTC and KTC′. As a function of the nature and the use of the resulting split terminal, exchanges may be initialized either by the first management device 27 of the terminal 20 or by the second management device 34 of the communicating equipment E 30, 30′.

If exchanges are initialized by the first management device 27 of the terminal 20, messages are sent to the second management device 34 of the communicating equipment E 30, 30′ via the communications interface 28, the third transmission interface 22, the connection network 50, the fourth transmission interface 31, and the communications interface 35. If exchanges are initialized by the second management device 34 of the communicating equipment E 30, 30′, messages are sent in the opposite direction, to the first management device 27 of the terminal 20, via the same interfaces.

Exchanges between the communications interface 26 and the third transmission interface 22, exchanges between the third and fourth transmission interfaces 22 and 31 on the connection network 50 and exchanges between the fourth transmission interface 31 and the communications interface 35 may employ the SOAP protocol, for example.

A new split terminal activation procedure may be started at any time during an existing activation. The new and total or partial activation procedure guarantees in time the identity, authenticity and integrity of the equipments used in said split terminal. If the new activation procedure fails, said split terminal is deactivated and communications in progress are stopped suddenly.

Execution of the activation procedure as described above may be simplified as a function of the required or desired level of security, for example by eliminating the second security device 32 of the communicating equipment E 30, 30′.

Simplification may also be achieved if the approval device 12 provided in the security server 10 for identifying, authenticating and checking the integrity of said communicating equipment E 30, 30′ is integrated into the terminal 20 or into the first security device 25.

In the same way, the functions of the approval device 12 of the security server 10 and the functions of the terminal 20 may be integrated into the security device 25 of said terminal 20. This is the case, for example, if the terminal 20 is an electronic identity card, integrating all the functions, and the split terminal comprises said identity card (i.e. the terminal 20) and a communicating terminal (i.e. the communicating equipment E 30, 30′).

Nevertheless, to be efficient, a split terminal activation procedure must comprise at least one check carried out by said first security device 25 of the terminal 20 to secure communication between said terminal 20 and the communicating equipment E 30, 30′ constituting said split terminal.

Use of the activation procedure may equally be made more complicated by dividing each security device into three separate devices, each dedicated to one specific function: identification, authentication or integrity checking. In this case, the identification, authentication and integrity checking of said communicating equipment E 30, 30′ are carried out by different and separate devices. The steps of said activation procedure are unchanged, but new messages are created and exchanged between the new devices to enable the exchange of data between them.

1. A method of communicating data securely between a terminal and at least one communicating equipment, which method comprises the steps of:
setting up at least one connection via at least one connection network between said terminal and said communicating equipment,
commanding at least one procedure for activation of said secure communication by at least one first security device installed in said terminal for assigning to management of the secure communication an identifier corresponding to said communicating equipment with which said communication has been set up, said identifier corresponding to said activation procedure,
said first security device identifying said communicating equipment in order to recognize the nature of said communicating equipment and to render said communicating equipment compatible with said terminal with no adaptation of the configuration,
authenticating said communicating equipment by acquiring data processed by at least one security server using at least one seal key and at least said identifier corresponding to said activation procedure in order to add a random value for said identified communicating equipment,
at least one approval device of said security server checking the integrity of said communicating equipment in order to verify if said communicating equipment has been corrupted using at least one integrity checking software executed on said transmitted data at the time of authentication and using random selection from a set of pairs of encryption keys for securing the decryption of said data,
comparing the result of decrypting the data processed by said integrity checking software of said security server and executed by said communicating equipment with the result of encrypting the identity of said equipment in said security server, and
in the case of identification, authentication and integrity checking results that are all positive and an identity result of said comparison, commanding at least one first management device installed in said terminal to set up secure data communication with said communicating equipment.

2. A secure data communications method according to claim 1, wherein, to prevent prediction of the result, the decryption of the data processed by said security server and executed by said communicating equipment depends on the integrity checking carried out by said approval device installed in said security server as a function of the configuration of said communicating equipment at a given time.

3. A secure data communications method according to claim 1, wherein exchange of data between said terminal and said communicating equipment is managed and controlled by means of at least one first security device and at least one second security device installed in said terminal and said communicating equipment, respectively, to share security management of said communication that has been set up.

4. A secure data communications method according to claim 1, wherein, to process the data before transmission and to validate a transmitted message, exchange of data between said terminal and said communicating equipment is secured by means of the condensate of at least one encryption key and at least said identifier corresponding to said activation procedure.

5. A secure data communications method according to claim 1, wherein, to process the data before transmission and to validate a transmitted message, exchange of data between said terminal and said security server is secured by using the condensate of at least one encryption key and at least said identifier corresponding to said activation procedure.

6. A secure data communications method according to claim 1, wherein, to increase the security of said set-up communication, the setting of at least one secure communications parameter is controlled by said first security device of terminal automatically, without intervention of a user of said terminal.

7. A secure data communications method according to claim 1, wherein said terminal receives a message regarding the stopping of the setting up of said communication by said user interface in the event of failure of identification, authentication or integrity checking.

8. A secure data communications method according to claim 1, wherein a plurality of communicating equipments simultaneously set up communication with said terminal via at least one connection network.

9. A secure data communications method according to claim 1, wherein a plurality of communicating equipments communicate independently with said terminal via said connection network by virtue of the identification of an activation procedure for each of said communicating equipments communicating with said terminal.

10. A system for communicating data securely between a terminal and at least one communicating equipment, wherein, communication having been set up between said terminal and said communicating equipment, said system comprises: said terminal, at least one communicating equipment communicating with said terminal, and at least one security server including at least one approval device adapted to validate the identification, authentication and integrity checking of at least one communicating equipment to secure said communication that has been set up with at least one first security device installed in said terminal which is equipped with at least one first management device for managing said communicating equipment.

11. A security server adapted to be used in a secure data communications system according to claim 10, wherein said server comprises at least one approval device adapted to validate the identification, authentication and integrity checking of at least one communicating equipment and means for sending and receiving data to be exchanged with said terminal.

12. A security server according to claim 11, wherein said approval device is integrated into said terminal.

13. A security server according to claim 11, wherein identification, authentication and integrity checking of said communicating equipment are effected by different and separate devices.

14. A terminal adapted to be used in a secure data communications system according to claim 10, wherein said terminal comprises at least one first security device for receiving the identity of said communicating equipment and dialoguing with said security server, at least one user interface for accessing the resources of said terminal to inform a user of said terminal, at least one first management device for managing said terminal, and means for sending and receiving data.

15. A communicating equipment including at least means for sending and receiving data to communicate with a terminal adapted to be used in a secure data communications system according to claim 10, wherein said communicating equipment comprises at least one second security device for identifying, authenticating and integrity checking said communicating equipment and at least one second management device for managing said terminal.

16. A communicating equipment according to claim 15, wherein said second security device and said second management device of said communicating equipment prohibit any intervention on said communicating equipment by said user of said mobile terminal.
